(19) United States
(12) Patent Application Publication
(10) Pub. No.: US 2025/0127236 A1
(43) Pub. Date: Apr. 24, 2025

(54) NICOTINE INTAKE ALERT METHOD, DEVICE AND ELECTRONIC CIGARETTE

(71) Applicant: Sunburse Wholesale Inc, Sacramento, CA (US)

(72) Inventor: Li Wang, Sacramento, CA (US)

(21) Appl. No.: 18/659,034

(22) Filed: May 9, 2024

(30) Foreign Application Priority Data
Oct. 18, 2023 (CN) 202311348573.9
Oct. 18, 2023 (CN) 202322792210.6

(51) Int. Cl. A24F 40/53; A24F 40/10; A24F 40/51; A24F 40/60; A24F 40/90; G08B 21/18

(52) U.S. Cl. CPC A24F 40/53; A24F 40/10; A24F 40/51; A24F 40/60; A24F 40/90; G08B 21/18

(57) ABSTRACT

The present application provides a nicotine intake alert method, a device, and an electronic cigarette, in which the smoking time of the user is obtained during a preset time interval, and the nicotine quantity of the tobacco oil in the tobacco oil compartment and the output power of the electronic cigarette are obtained. The nicotine intake can be calculated according to the smoking time, the nicotine quantity, and the output power, so that the alert message can be output according to the nicotine intake. Accordingly, the real-time nicotine intake can be accurately calculated by combining the smoking time, the nicotine quantity, and the output power during the process of smoking the electronic cigarette, and the corresponding alert message is outputted, thereby intuitively alerting the user of the nicotine intake, avoiding the user from smoking an excessive amount of nicotine, and providing the user with a better smoking experience.

### CROSS-REFERENCE TO RELATED APPLICATIONS

This application claims the benefit of priority of Chinese Patent Application No. 202311348573.9 filed on Oct. 18, 2023, entitled “NICOTINE INTAKE ALERT METHOD, DEVICE AND ELECTRONIC CIGARETTE”, and Chinese Patent Application No. 202322792210.6 filed on Oct. 18, 2023, entitled “ELECTRONIC CIGARETTE”, the entire contents of which are incorporated herein by reference.

### TECHNICAL FIELD

The present application relates to the technical field of electronic cigarette atomizers, in particular to a nicotine intake alert method, a device, and an electronic cigarette.

### BACKGROUND

An electronic cigarette is an electronic atomization device designed to simulate the experience of traditional tobacco combustion, providing smoke and oral satisfaction. Compared to traditional cigarettes, it does not contain harmful substances such as tar and carbon monoxide produced by combustion, but the smoke it produces still contains substances such as nicotine.

Currently, in the related art, electronic cigarettes often cannot accurately assess the user's nicotine intake and cannot provide reminders to users about their nicotine intake. Traditional electronic cigarette technology relies on the user's subjective feelings and usage habits to assess nicotine intake, which is uncertain and subjective, leading to the risk of users ingesting excessive nicotine in a short period. This not only fails to provide a better smoking experience but also increases the risk of nicotine overdose, resulting in symptoms such as nicotine poisoning, nausea, and physical discomfort.

Therefore, there is an urgent need to propose an electronic cigarette capable of performing nicotine intake alerts, so as to monitor nicotine intake and provide alerts to avoid the problem of nicotine overdose.

### SUMMARY

The present application provides a nicotine intake alert method, a device, and an electronic cigarette, which can monitor nicotine intake and provide alerts, so as to avoid the problem of nicotine overdose and improve the user's electronic cigarette smoking experience.

In a first aspect, embodiments of the present application provide a nicotine intake alert method, applied to an electronic cigarette, comprising:
obtaining a smoking time of a user during a preset time interval;
obtaining a nicotine quantity of a tobacco oil in a tobacco oil compartment and an output power of the electronic cigarette;
calculating a nicotine intake according to the smoking time, the nicotine quantity of the tobacco oil, and the output power; and
outputting an alert message according to the nicotine intake.

In one embodiment, the smoking time is a duration from when the user triggers smoking start to when the user triggers smoking stop; or, the smoking time is a duration from when an airflow sensor of the electronic cigarette begins detecting smoke airflow to when the smoke airflow is no longer detected.

In one embodiment, the step of obtaining the nicotine quantity of the tobacco oil in the tobacco oil compartment and the output power of the electronic cigarette comprises:
receiving a detection signal sent by a detecting unit of the electronic cigarette when the tobacco oil compartment is loaded with the electronic cigarette;
determining the nicotine quantity of the tobacco oil in the tobacco oil compartment according to the detection signal.

In one embodiment, the detecting unit comprises a plurality of detecting portions, each detecting portion being configured to generate a trigger signal according to a mechanical detection marking of the tobacco oil compartment; accordingly, the step of receiving the detecting signal sent by the detecting unit of the electronic cigarette comprising:
receiving a trigger signal sent by each detecting portion, and generating the detection signal according to the trigger signals of the plurality of detecting portions.

In one embodiment, the step of calculating nicotine intake according to the smoking time, the nicotine quantity of the tobacco oil, and the output power comprises:
calculating the nicotine intake using a fitting function with the smoking time, the nicotine quantity of the cigarette oil, and the output power as variables, wherein the fitting function is:

$$C = k * T * P * N ;$$

wherein C is the nicotine intake in mg; k is a fitting coefficient; T is the smoking time in s; P is the output power in W; and N is the nicotine quantity of the tobacco oil in mg/ml.

In one embodiment, the step of outputting alert information according to the nicotine intake comprises:
calculating a ratio of the nicotine intake to a maximum nicotine intake; wherein the maximum nicotine intake is a maximum value of the nicotine intake within a preset time; and
outputting the ratio.

In one embodiment, the electronic cigarette comprises a plurality of display lights, and the step of outputting the ratio comprises:
calculating a display light ratio of one display light to all the number of the display lights;
determining a maximum positive integer of the ratio divided by the display light ratio; and
displaying a number of display lights, wherein the number is the maximum positive integer.

In one embodiment, the method further comprises:
outputting at least one of a vibration alert message and an acoustic alert message when the nicotine intake reaches the maximum nicotine intake.

In a second aspect, embodiments of the present application further provide a nicotine intake alert device, applied to an electronic cigarette, comprising:
a time obtaining module configured to obtain a smoking time of a user during a preset time interval;
a nicotine quantity and output power obtaining module configured to obtain a nicotine quantity of a tobacco oil in a tobacco oil compartment and an output power of the electronic cigarette;
a calculating module configured to calculate a nicotine intake according to the smoking time, the nicotine quantity of the tobacco oil, and the output power; and
an output module configured to output an alert message according to the nicotine intake.

In a third aspect, embodiments of the present application further provide an electronic cigarette, comprising a memory and a processor;
wherein the memory is configured to store an executable program code; and
the processor is configured to call the executable program code in the memory to perform a nicotine intake alert method comprising:
obtaining a smoking time of a user during a preset time interval;
obtaining a nicotine quantity of a tobacco oil in a tobacco oil compartment and an output power of the electronic cigarette;
calculating a nicotine intake according to the smoking time, the nicotine quantity of the tobacco oil, and the output power; and
outputting an alert message according to the nicotine intake.

In a fourth aspect, embodiments of the present application provide an electronic cigarette, comprising: a casing, an atomizer, a controller, a battery, and a display light;
wherein the atomizer is arranged through a top of the casing, and at least a portion of the atomizer is arranged on the top of the casing; the controller and the battery are arranged in the casing, and the atomizer and the battery are electrically connected to the controller; the display light is arranged on a surface of the casing and electrically connected to the controller; and the display light is configured to display in response to a control signal from the controller.

In one embodiment, the electronic cigarette further comprises a timing device, which is arranged in the casing and electrically connected to the controller.

In one embodiment, the display light is a strip light, and a length direction of the strip light is parallel or perpendicular to a height direction of the casing.

In one embodiment, the display light is a strip light, the strip light encircling to form a circular shape.

In one embodiment, the number of the display lights is three, and the three display lights are sequentially arranged along a height direction of the casing.

In one embodiment, the electronic cigarette further comprises a vibration motor, which is arranged within the casing and electrically connected to the controller.

In one embodiment, the electronic cigarette further comprises a loudspeaker, which is arranged within the casing and electrically connected to the controller.

In one embodiment, the electronic cigarette further comprises a button, the button being provided on the casing and electrically connected to the controller.

In one embodiment, the button is wherein the button is a touchable button.

In one embodiment, a charging port is further provided at a bottom of the casing; the charging port is electrically connected to the battery and configured to charge the battery.

In the nicotine intake alert method provided in the present application, the smoking time of the user is obtained during a preset time interval, and the nicotine quantity of the tobacco oil in the tobacco oil compartment and the output power of the electronic cigarette are obtained. The nicotine intake can be calculated according to the obtained smoking time, the nicotine quantity of the tobacco oil, and the output power, so that the alert message can be output according to the nicotine intake. Accordingly, the real-time nicotine intake can be accurately calculated by combining the smoking time, the nicotine quantity of the tobacco oil, and the output power during the process of smoking the electronic cigarette, and the corresponding alert message is outputted, thereby intuitively alerting the user of the nicotine intake, avoiding the user from smoking an excessive amount of nicotine, and providing the user with a better smoking experience.

### BRIEF DESCRIPTION OF THE DRAWINGS

In order to more clearly illustrate the technical solutions in the embodiments or related art of the present application, the accompanying drawings to be used in the description of the embodiments or the related art will be briefly described hereinafter. Obviously, the accompanying drawings in the description hereinafter are only some of the embodiments of the present application, and that other accompanying drawings may be obtained according to the accompanying drawings for those of ordinary skill in the field, without any creative labor. The accompanying drawings herein are incorporated into and form a part of the specification, illustrate embodiments in accordance with the present application, and are used with the specification to explain the principles of the present application.

FIG. 1 shows a structural schematic diagram of an electronic cigarette according to an embodiment of the present application.

FIG. 2 shows a structural diagram of a casing of the electronic cigarette according to an embodiment of the present application.

FIG. 3 shows a structural schematic diagram of a display light of the electronic cigarette according to an embodiment of the present application.

FIG. 4 shows a structural schematic diagram of the display light of the electronic cigarette according to another embodiment of the present application.

FIG. 5 shows a structural schematic diagram of the display light of the electronic cigarette according to a yet another embodiment of the present application.

FIG. 6 shows a flowchart of a nicotine intake alert method according to an embodiment of the present application.

FIG. 7a shows a flowchart of the step S100 according to an embodiment of the present application.

FIG. 7b shows a flowchart of the step S100 according to another embodiment of the present application.

FIG. 8 shows a flowchart of the step S200 according to an embodiment of the present application.

FIG. 9a shows a structural schematic diagram of a tobacco oil compartment loaded into the electronic cigarette according to an embodiment of the present application.

FIG. 9b shows a structural schematic diagram of a tobacco oil compartment loaded into an electronic cigarette according to an embodiment of the present application.

FIG. 10 shows a structural schematic diagram of the display light of the electronic cigarette according to an embodiment of the present application.

FIG. 11 shows a structural schematic diagram of a nicotine intake alert device according to an embodiment of the present application.

FIG. 12 shows a structural schematic diagram of an electronic cigarette according to an embodiment of the present application.

By means of the above accompanying drawings, definite embodiments of the present application have been shown, which will be described in more detail later. These accompanying drawings and textual descriptions are not intended to limit the protection scope of the present application idea by any means, but rather to illustrate the concepts of the present application for those skilled in the art by reference to particular embodiments.

### DETAILED DESCRIPTION OF THE EMBODIMENTS

In order to make the object, technical solutions and advantages of the embodiments of the present application clearer, the technical solutions in the embodiments of the present application will be described clearly and completely in the following in conjunction with the accompanying drawings in the embodiments of the present application. Obviously, the described embodiments are a part of the embodiments of the present application rather than all of the embodiments. According to the embodiments in the present application, all other embodiments obtained by persons of ordinary skill in the art without making creative labor fall within the protection scope of the present application.

Currently, electronic cigarettes (also known as, electronic cigarette atomizers) in the related art often cannot accurately measure the user's nicotine intake and cannot provide alerts for nicotine intake. Traditional e-cigarette technology relies on users' subjective sensations and usage habits to assess nicotine intake, which leads to uncertainty and subjectivity. This can easily result in users consuming excessive nicotine in a short period, leading not only to an unsatisfactory smoking experience but also to nicotine poisoning, nausea, and physical discomfort.

In order to solve the above problem, the present application provides an electronic cigarette with a plurality of display lights, and the plurality of display lights can be illuminated according to the nicotine intake of the user in the process of smoking the electronic cigarette, thereby intuitively alerting the user of the amount of nicotine intake, and providing the user with a better smoking experience.

The electronic cigarette provided in the embodiments of the present application is described in detail below in combination with specific embodiments.

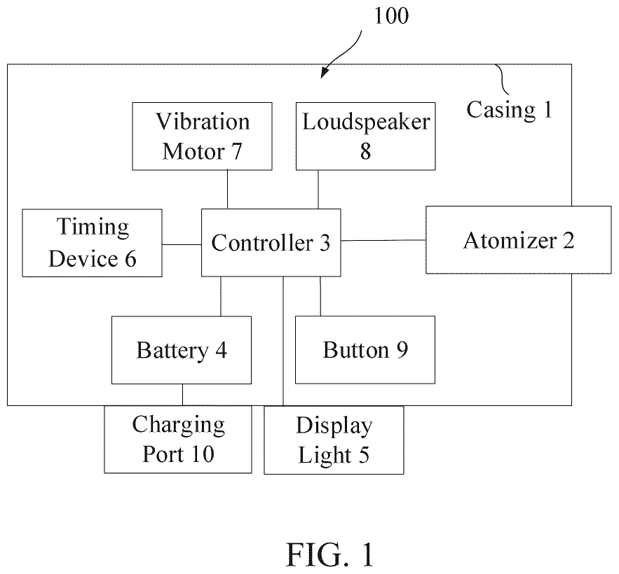

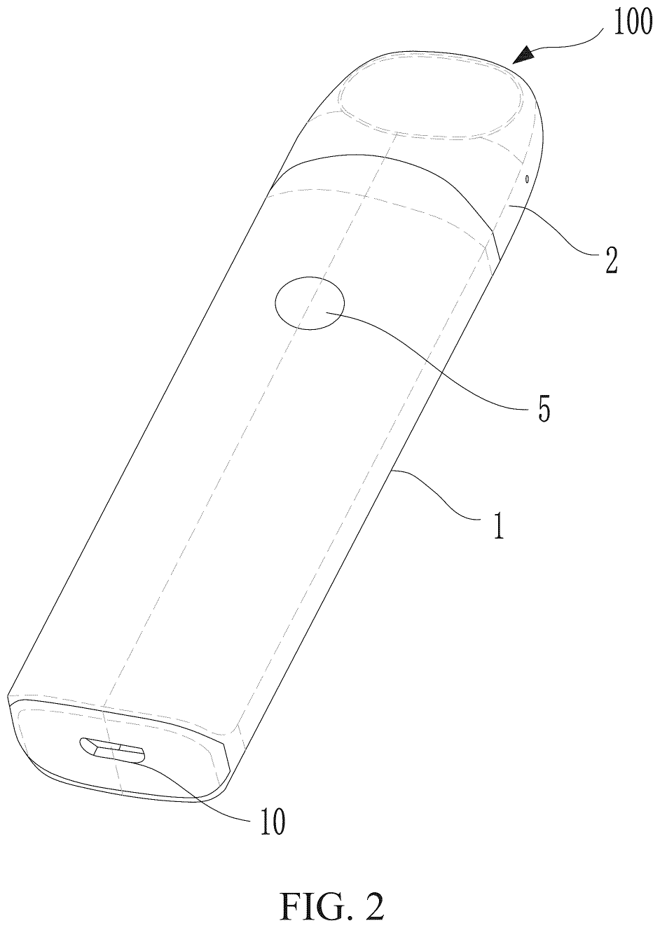

FIG. 1 is a structural schematic diagram of an electronic cigarette according to an embodiment of the present application, and FIG. 2 is a structural diagram of a casing of the electronic cigarette according to an embodiment of the present application. As shown in FIGS. 1 and 2, an embodiment of the present application provides an electronic cigarette 100, including a casing 1, an atomizer 2, a controller 3, a battery 4, and a display light 5. The atomizer 2 is arranged through a top of the casing 1 and at least a portion of the atomizer 2 is arranged on the top of the casing 1. The controller 3 and the battery 4 are provided within the casing 1, and the atomizer 2 and the battery 4 are electrically connected to the controller 3. The display light 5 is provided on a surface of the casing 1 and is electrically connected to the controller 3. The display light 5 is configured to light up according to a control signal from the controller 3.

Specifically, the casing 1 of the electronic cigarette 100 of the embodiment of the present application is an external package of the electronic cigarette for casing and protecting the internal components. This casing 1 may be made of materials such as metal, plastic or glass, which have certain heat and corrosion resistance. Moreover, the casing 1 of the electronic cigarette 100 of the present application may be constructed to fit the shape of the human hand, thereby providing a comfortable handhold so that the user can easily carry and use the electronic cigarette 100.

Specifically, the atomizer 2 of the electronic cigarette 100 of the embodiment of the present application is arranged through the top of the casing 1, and the atomizer 2 may include a nozzle, an atomization chamber, a heating coil, and an oil injection core. The nozzle is arranged through the top of the casing 1 and extends outwardly to form a smoke outlet. When the user inhales the electronic cigarette 100, the controller 3 activates the heating coil or hot wire to heat it to a predetermined temperature. The heated coil or hot wire heats the tobacco oil to convert it into vapor or mist.

Specifically, the controller 3 of this embodiment of the present application is a control component of the electronic cigarette 100 for managing various functions and settings of the electronic cigarette. It may be an electronic chip or microcontroller, such as a Microprogrammed Control Unit (MCU) chip, a Digital Signal Processor (DSP) chip, a Field-programmable Gate Array (FPGA) chip, an Application Specific Integrated Circuit (ASIC) chip, etc., with the ability to process and respond to user inputs. In the embodiment of the present application, the controller 3 is provided in a middle part of the casing 1 and establishes an electrical connection with the electronic components, such as the atomizer 2 and the battery 4, to control the generation of smoke by controlling the output power of the battery, adjusting the temperature of the heating coil, and the like.

Specifically, the battery 4 of the embodiment of the present application may be a non-rechargeable battery or a rechargeable battery, and is provided at a bottom within the casing 1. The battery 4 establishes an electrical connection with the electronic components, such as the atomizer 2, the controller 3, the display light 5, etc., in order to provide a power supply so that the electronic cigarette 100 can work properly.

Specifically, the display light 5 of the embodiment of the present application is provided on the surface of the casing 1 and establishes an electrical connection with the controller 3. The number of the display lights 5 may be one or more, and these display lights 5 may be LED lights or LED strips, etc., for providing light indication. According to the control signal from the controller 3, the display light 5 can illuminate, flash, change colors, or vary in brightness to convey the nicotine intake of the electronic cigarette 100. The following embodiments mainly illustrate the scheme of displaying the display light by illumination and changing colors. However, flashing or varying brightness may also be used for display, and this is not limited herein.

Through the combination of the above structural components, the electronic cigarette 100 of the embodiment of the present application is capable of heating the tobacco oil, generating inhalable smoke, and providing a display of the nicotine intake through the display light 5, providing the user with a convenient use experience and visualized feedback. When the controller 3 controls the display light 5 to light up, the user can visualize the nicotine intake information of the electronic cigarette 100 to avoid excessive nicotine intake and thus develop good electronic cigarette smoking habits.

In one embodiment, the electronic cigarette 100 in the present application further includes a timing device 6, which is provided in the casing 1 and electrically connected to the controller 3. Specifically, the timing device 6 may be a specialized counter chip or a timing module integrated within the controller chip, without limitation herein. In the specific realization process, when the user uses the electronic cigarette 100, the controller 3 sends out a start signal and activates the timing device 6 to start timing, thereby measuring the time interval of a single smoking by the user. The controller 3 may therefore determine the nicotine intake according to the timing information of the timing device 6 in accordance with a preset calculation rule, and send a control signal to the display light 5 according to the nicotine intake to illuminate the display light 5, thereby intuitively alerting the user of the corresponding nicotine intake. It is worth stating that the preset calculation rules herein are measured experimentally in advance. For Example, it is taken that the electronic cigarette with grapefruit ice tobacco oil as an example, the electronic cigarette 100 in the present application is output at a fixed power, and according to the maximum value of nicotine intake for a single inhalation of 0.0425 mg, the user can reach the maximum amount of nicotine intake by inhaling for 3 s through experimental calculations, and thus a control signal may be sent when the user is inhaling for 3 s, and control the display light 5 to display. Of course, this preset calculation rule may also be combined with factors such as the power of the electronic cigarette, the type of tobacco oil, and so on, to adjust the smoking time to reach the maximum nicotine intake, which will not be limited herein.

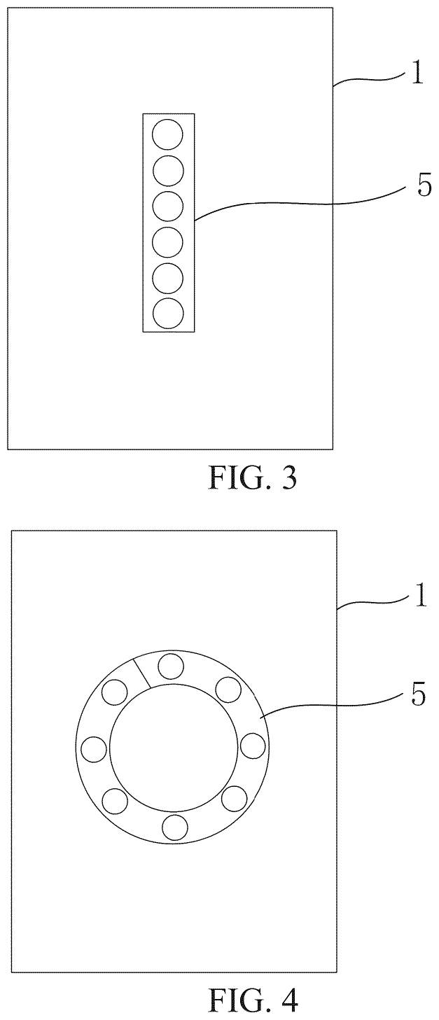

In one embodiment, as shown in FIG. 3, the display light 5 is a strip light, and a length direction of the strip light is parallel to a height direction of the casing 1. Specifically, the strip light in this embodiment includes a plurality of LEDs, and the plurality of LEDs extend along the length direction of the strip light. In this embodiment, the length direction of the strip light is parallel to the height direction of the casing 1. In other embodiments, the length direction of the strip-mounted light strip may be perpendicular to the height direction of the casing 1, or intersect with the height direction of the casing 1 with a preset angle, such as 45°, which is not limited herein. Specifically, in this embodiment, the number of LEDs of the strip-mounted light strip is three, and each LED may be realized to be independently controlled in segments. In the specific realization process, the controller 3 receives timing information from the timing device 6, thereby lighting each LED light of the strip light respectively. For example, when the timing information is 1 s, the controller 3 controls the lighting of the first LED light (i.e., the LED at the lowest end) of the strip light. When the timing information is 2 s, the controller 3 controls the lighting of the first LED light and the second LED light of the strip light. When the timing information is 3 s, the controller 3 controls the lighting of all three LED lights of the strip light. By adopting the technical solution of this embodiment, the user can visualize the nicotine intake throughout the process of smoking the electronic cigarette 100, thereby avoiding excessive nicotine smoking and benefiting the user's health.

In another embodiment, as shown in FIG. 4, the display light 5 is a strip light, and the strip light surrounds to form a circular shape. In this embodiment, the strip light surrounds to form a circular shape, i.e., the head and tail of the strip light are connected. Therein, the specific structure and realization process of the strip light belt are consistent with the above embodiments and are not limited herein. By adopting the technical solution of this embodiment, the user's nicotine intake will be displayed by the corresponding circular-shaped LED lights, so that the user can more intuitively understand the percentage of the current smoking amount and the maximum smoking amount (i.e., more similar to the pie chart of the data statistics), which can give the user a different visual experience to satisfy the needs of different users.

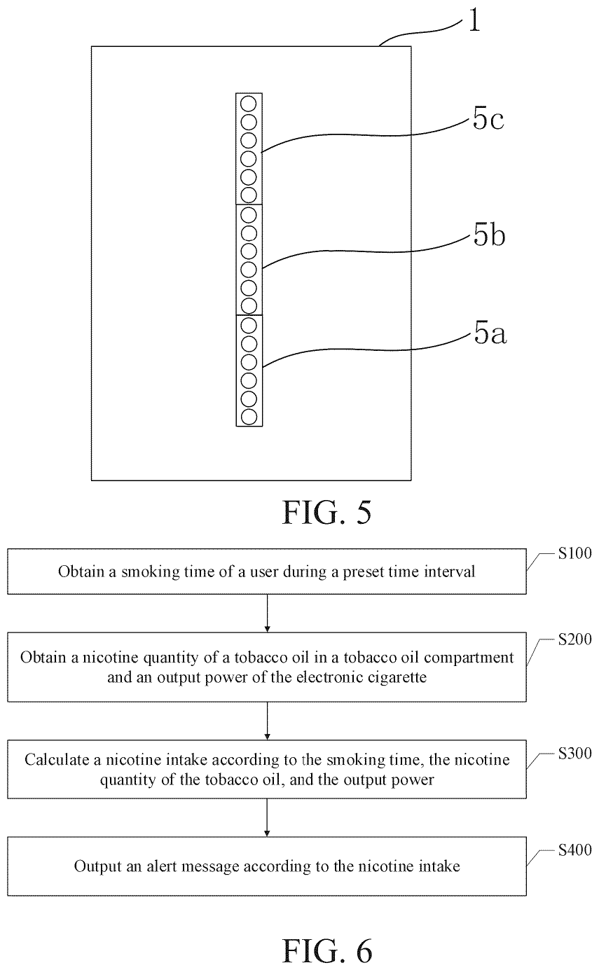

In one embodiment, as shown in FIG. 5, the number of display lights 5 is three, and the three display lights 5 are sequentially arranged along the height direction of the casing 1. Specifically, the display lights 5 may be single LED lights or strip lights, and the strip lights are illustrated below as an example. In this embodiment, the casing 1 of the electronic cigarette 100 is provided with three strip lights, and the three strip lights are sequentially arranged along the height direction of the casing 1. It is worth stating that the number of display lights 5 may be 1, 2, 3, or more, which is not limited herein.

For example, the three strip lights are sequentially defined from low to high as the first strip light 5a, the second strip light 5b, and the third strip light 5c. In the specific realization process, when the timing information is 0-2 s, the LEDs of the first strip light 5a are sequentially illuminated from the bottom end of the first strip light 5a, and all of the LEDs of the first strip light 5a are illuminated when 2 s is reached. When the timing information is 2-4 s, the LEDs of the second strip light 5b are sequentially illuminated from the bottom end of the second strip light 5b, and all of the LEDs of the second strip light 5b are illuminated when 4 s is reached, and the first strip light 5a is kept lit during this process. When the timing information is 4-6 s, the LED lights of the third strip light 5c are sequentially illuminated from the bottom end of the third strip light 5c, and all of the LEDs of the third strip light 5c are illuminated when 6 s is reached, and the first strip light 5a and the second strip light 5b are kept lit in the process. By adopting the technical solution of this embodiment, a real-time display of nicotine intake in segments can be realized, which allows the user to intuitively perceive the amount of nicotine intake, avoiding overdose of nicotine, and is conducive to the user's physical health.

In one embodiment, the electronic cigarette 100 further includes a vibration motor 7, which is provided within the casing 1 and electrically connected to the controller 3. Specifically, the vibration motor 7 may be a direct current (DC) motor or a vibration motor, which is configured to vibrate according to the control signal of the controller 3. In the specific implementation process, when the user smoking the electronic cigarette reaches the maximum nicotine intake (e.g., the timing information is 6 s), the controller 3 sends out a control signal, thereby controlling the vibration motor 7 to vibrate so as to remind the user to stop smoking the electronic cigarette. By adopting the technical solution of this embodiment, not only the visual alert is carried out by the display light 5, but also the tactile alert is carried out by the vibration motor 7, so as to allow the user to intuitively perceive the amount of nicotine intake from both visual and tactile perception dimensions to avoid excessive nicotine smoking.

In one embodiment, the electronic cigarette 100 of the present application further includes a loudspeaker 8, which is provided within the casing 1 and electrically connected to the controller 3. Specifically, the loudspeaker 8 is configured to carry out an acoustic alert according to the control signal of the controller 3. In the specific implementation, when the user smoking the electronic cigarette reaches the maximum nicotine intake (e.g., the timing information is 6 s), the controller 3 sends out a control signal, thereby controlling the loudspeaker 8 to carry out the acoustic reminder so as to alert the user to stop smoking the electronic cigarette. By adopting the technical solution of this embodiment, not only the visual alert is carried out through the display light 5, but also the acoustic alert is carried out through the loudspeaker 8, thereby allowing the user to intuitively perceive the nicotine intake from both visual and auditory perception dimensions to avoid excessive nicotine smoking.

In one embodiment, the electronic cigarette 100 of the present application includes both the vibration motor 7 and the loudspeaker 8, the specific structure of which is the same as that of the above embodiment and will not be repeated herein. In the specific implementation process, when the user smoking the electronic cigarette reaches the maximum nicotine intake (e.g., the timing information is 6 s), the controller 3 sends out a control signal, thereby controlling the vibration of the vibration motor 7 to vibrate as well as the acoustic alert of the loudspeaker 8, so as to alert the user to stop smoking the electronic cigarette. By adopting the technical solution of this embodiment, not only the visual alert is carried out by the display light 5, but also the tactile alert is carried out by the vibration motor 7 and the acoustic alert is carried out by the loudspeaker 8, so as to allow the user to intuitively perceive the amount of nicotine intake from the three perceptual dimensions of vision, tactile sensation, and audibility, so as to avoid excessive nicotine smoking.

In one embodiment, the electronic cigarette 100 of the present application is provided with a display light 5 as described in the above embodiment, and the display light 5 can not only carry out a nicotine intake alert, but also carry out a power level display and/or an oil level display. Specifically, the controller may acquire the current power level of the battery 4 and generate a power level display control signal according to the current power level of the battery 4. When the current power level of the battery 4 is greater than 20%, the power level display control signal controls the display color of the display light 5 to be white. When the current power level of the battery 4 is less than or equal to 20%, the power level display control signal controls the display color of the display light 5 to be yellow, so as to prompt the user to charge in time. In addition, the controller may also obtain the current oil level of the tobacco oil compartment through a sensor provided in the tobacco oil compartment, and generate the oil level display control signal according to the current oil level of the tobacco oil compartment. In this embodiment, the display light 5 is illuminated with a delay of 5s after the user has finished smoking, and when the current oil quantity of the tobacco oil compartment is greater than 20%, the oil quantity display control signal controls the display color of the display light 5 to be white. When the current oil quantity of the tobacco oil compartment is less than 20%, the oil quantity display control signal controls the display color of the display light 5 to be yellow in order to remind the user that the tobacco oil in the tobacco oil compartment is about to run out of tobacco oil. When there are a plurality of display lights 5, any one of the display lights may be preset as the oil quantity display light to carry out the above-mentioned oil quantity display process, and the other display lights do not carry out the display, so that the power quantity display and the oil quantity display are differentiated, so that the user can distinguish them more easily. It should be understood that the above embodiments are merely examples, and the colors of the display lights in different states and the critical value of the changing colors may also be changed according to the practical needs of the user. For example, the color of the display lights is green when the power or the oil quantity is greater than 20%, and the color of the display lights is red when the power or the oil quantity is less than or equal to 20%. For another example, the critical value of the changing color of the power or oil quantity may be set to be 10%, 20%, 30%, etc., and not all examples are given herein.

In one embodiment, the electronic cigarette 100 of the present application further includes a button 9, which is provided on the casing 1 and is electrically connected to the controller 3. Specifically, the button 9 is configured to receive a power level displaying request or an oil level displaying request input by the user, and send the request instruction input by the user to the controller 3. When the request instruction input by the user is a power level displaying request, the controller 3 obtains the remaining power level information of the battery 4, generates a power level display instruction according to the power level display rules, and controls the display light 5 to display according to the power level display instruction. For example, the display light 5 with three strip lights in FIG. 5 is taken as an example, if ⅓ of the power is remaining, the power display instruction is to instruct the first strip light 5a to be displayed so as to enable the user to obtain the remaining power information of the battery 4. When the request instruction inputted by the user is an oil quantity display request, the controller 3 obtains the remaining oil quantity information of the tobacco oil compartment (not shown in the figure) of the electronic cigarette 100, generates an oil quantity display instruction in accordance with the oil quantity display rule, and controls the display light 5 to be displayed by the oil quantity display instruction. For example, the display light 5 with three strip lights in FIG. 5 is taken as an example, if ⅓ of the oil quantity of the tobacco oil compartment is remaining, the oil quantity display instruction is to instruct the first strip light 5a to be displayed so as to enable the user to obtain the remaining oil quantity information of the tobacco oil compartment.

Specifically, the button 9 may include a first key and a second key (not shown in the figure). The first key is configured to receive the power level displaying request inputted by the user, and the second key is configured to receive the oil level displaying request inputted by the user. In another embodiment, the number of keys 9 is only one, and the key is pressed in different ways to characterize different display requests, such as by a short press (less than 1 s) to characterize the power level displaying request, and by a long press (greater than or equal to 1 s) to characterize the oil level displaying request.

In one embodiment, the button 9 is a touchable button. Specifically, the casing 1 of the electronic cigarette 100 of the present application is provided with a touch display screen, and the touchable key is a trigger control provided on the touch display screen. By providing the touchable button, the touchable button may be customized according to the design and functional requirements of the electronic cigarette, thereby enriching the use of the touchable button.

In one embodiment, a charging port 10 is also provided at the bottom of the casing 1, and the charging port 10 is electrically connected to the battery 4 and configured to charge the battery 4. In this embodiment, the battery 4 is a rechargeable battery, and the charging port 10 can connect the electronic cigarette 100 to a charging device to charge the rechargeable battery. The charging port 10 may be a USB interface, a Type-C interface, a Lighting interface, or the like, which is not specifically limited herein.

In one embodiment, the present application further provides a nicotine intake alert method, the smoking time of the user is obtained during a preset time interval, and the nicotine quantity of the tobacco oil in the tobacco oil compartment and the output power of the electronic cigarette are obtained. The nicotine intake can be calculated according to the obtained smoking time, the nicotine quantity of the tobacco oil, and the output power, so that the alert message can be output according to the nicotine intake. Accordingly, the real-time nicotine intake can be accurately calculated by combining the smoking time, the nicotine quantity of the tobacco oil, and the output power during the process of smoking the electronic cigarette, and the corresponding alert message is outputted, thereby intuitively alerting the user of the nicotine intake, avoiding the user from smoking an excessive amount of nicotine, and providing the user with a better smoking experience.

The nicotine intake alert method provided in the embodiments of the present application is described in detail below in combination with specific embodiments. This method may be applied to the electronic cigarette as shown in FIG. 2, and of course, it may also be applied to electronic cigarettes of other structures, which will not be limited herein.

FIG. 6 shows a flowchart of a nicotine intake alert method according to an embodiment of the present application. As shown in FIG. 6, the nicotine intake alert method provided by embodiments of the present application, applied to the electronic cigarette 100 as shown in FIG. 2, includes the following steps.
Step S100: a smoking time of the user is obtained in a preset time interval.

Specifically, the preset time interval is a complete smoking cycle for counting one smoking time, and the preset time interval may be a factory default value of the electronic cigarette or a value set by the user during use. It may include a smoking time and a stopping time, for example, “smoke 1 stop 9”, i.e., the preset time is 10 s, the smoking time is 1 s, and the stopping time is 9 s.

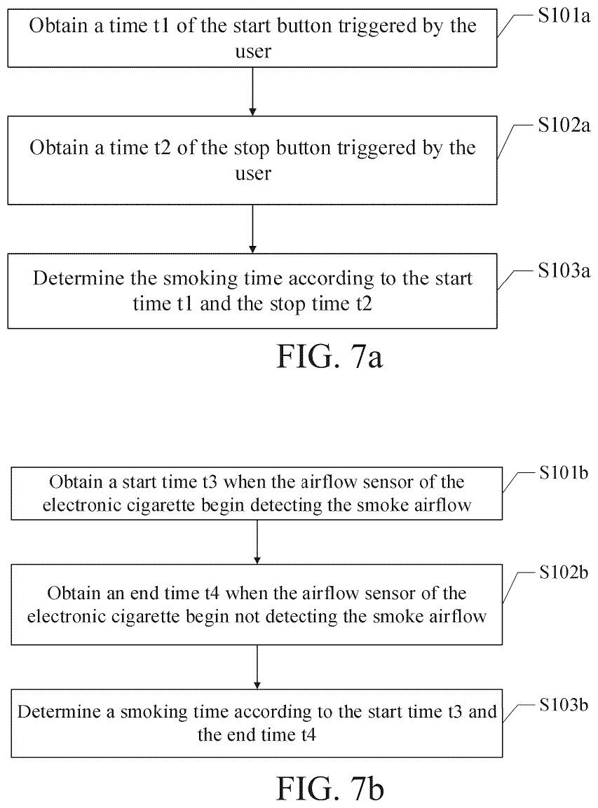

In an embodiment of the present application, the smoking time is a duration when the user triggers smoking start to when the user triggers smoking stop. Specifically, the casing of the electronic cigarette of the present application may be provided with a start button and a stop button, and the user may trigger the start button and the stop button to start and stop the electronic cigarette working. As shown in FIG. 7a, the step S100 of obtaining the smoking time of the user during a preset time interval includes the following steps.
Step S101a: a time t1 of the start button triggered by the user is obtained.
Step S102a: a time t2 of the stop button triggered by the user is obtained.
Step S103a: the smoking time is determined according to the start time t1 and the stop time t2.

The smoking time of the user may be easily obtained by the time when the user triggers the start button and the stop button, in which the start time of the preset time interval is the time t1 of the start button triggered by the user, and the smoking time is (t2−t1). With this approach, the acquisition of the smoking time can be realized without the need for an additional detection device.

In another embodiment of the present application, the smoking time is a duration from when an airflow sensor of the electronic cigarette begins detecting smoke airflow to when the smoke airflow is no longer detected. Specifically, an airflow sensor is provided at the nozzle of the electronic cigarette, and the airflow sensor detects whether the user is smoking. As shown in FIG. 7b, the step S100 of obtaining the smoking time of the user in the preset time interval includes the following steps.
Step S101b: a start time t3 when the airflow sensor of the electronic cigarette begins detecting the smoke airflow is obtained.
Step S102b: an end time t4 when the airflow sensor of the electronic cigarette begins not detecting the smoke airflow is obtained.
Step S103b: a smoking time is determined according to the start time t3 and the end time t4.

The moment that the airflow sensor of the electronic cigarette begins detecting the smoke airflow is taken as the starting time, and the moment that the smoke airflow is no longer detected is taken as the ending time. The start time t3 of the predetermined time interval is the moment that the smoke airflow is begin detected by the airflow sensor, and the smoking time is (t4−t3). With this approach, it is possible to more accurately detect whether the user is inhaling or not, in order to obtain a more accurate smoking time, thereby making the calculation of nicotine intake more accurate. Specifically, the airflow sensor herein may be a photoelectric sensor, a thermal airflow sensor, a piezoresistive airflow sensor, and the like, which is not limited herein.
Step S200: a nicotine quantity of a tobacco oil in a tobacco oil compartment and an output power of the electronic cigarette are obtained.

Specifically, the controller of the electronic cigarette works according to the output power set by the user, which may be a constant power output or a variable power output, so that the output power of the electronic cigarette may be directly obtained.

If the electronic cigarette is a disposable electronic cigarette or a pre-filled electronic cigarette, since the tobacco oil has been pre-filled into the tobacco oil compartment of the electronic cigarette device, the nicotine quantity of the tobacco oil in the tobacco oil compartment may be read from the memory of the electronic cigarette, or input information from the user may also be obtained so as to determine the nicotine quantity of the tobacco oil in the tobacco oil compartment.

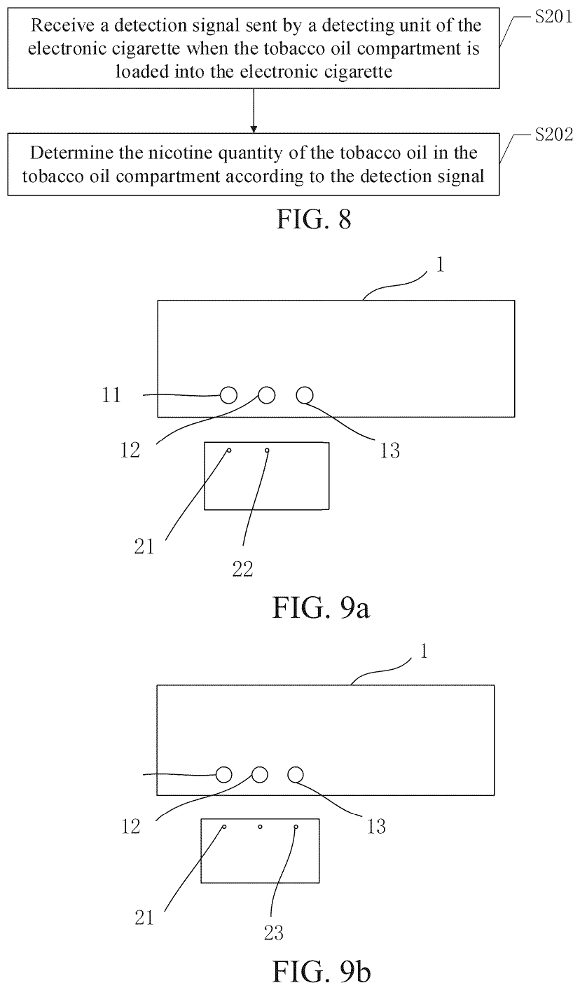

If the electronic cigarette is an open electronic cigarette or a replaceable cartridge electronic cigarette, the user may change the electronic cigarette according to his/her preference. In one embodiment, as shown in FIG. 8, the step S200 of obtaining the nicotine quantity of the tobacco oil of the tobacco oil compartment includes the following steps.
Step S201: a detection signal sent by a detecting unit of the electronic cigarette is received when the tobacco oil compartment is loaded into the electronic cigarette.
Step S202: the nicotine quantity of the tobacco oil in the tobacco oil compartment is determined according to the detection signal.

Specifically, the tobacco oil compartment is provided with a detection marking and the electronic cigarette is provided with a detecting unit. When the tobacco oil compartment is loaded into the electronic cigarette, the detecting unit automatically recognizes the detection marking loaded into the tobacco oil compartment to generate a detection signal, so that the controller can determine the nicotine quantity information of the tobacco oil in the tobacco oil compartment according to the detection signal. In one embodiment, the tobacco oil compartment and the electronic cigarette may be connected by wireless near-field communication technology, for example, by using Near Field Communication (NFC), where the detection marking on the tobacco oil compartment is an NFC tag, and the electronic cigarette is correspondingly provided with an NFC receiving end. For example, if Radio Frequency Identification (RFID) communication is adopted, the detection marking on the tobacco oil compartment is an RFID tag or an RFID card, and a reader-writer is set up on the electronic cigarette. By adopting the near-field communication method, it is possible to accurately obtain information about the identification of the tobacco oil compartment in which the electronic cigarette is loaded, so as to determine the nicotine quantity of the tobacco oil in the tobacco oil compartment.

In another embodiment, the tobacco oil compartment is provided with a mechanical detection marking, such as a mechanical structure such as a stopper, a bump, and the like. Correspondingly, the electronic cigarette is provided with a mechanical detecting unit, such as a mechanical portion that can be triggered including, but not limited to, a flick switch, an optocoupler, a force sensor, and the like, so as to obtain the detection signal by means of a mechanical contact.

Specifically, the detecting unit includes a plurality of detecting portions, each of which is configured to generate a trigger signal according to a mechanical detection marking of the tobacco oil compartment. Accordingly, the step S201 of receiving the detection signal sent by the detecting unit of the electronic cigarette includes the following steps.

The trigger signal sent by each detecting portion is received and the detection signal is generated according to the trigger signals of the plurality of detecting portions.

Specifically, the detecting unit may include a plurality of detecting portions, and the mechanical detection marking of the tobacco oil compartment may include a plurality of detection markings. Different types of tobacco oil compartments have different combinations of detection marking, and any one of the detecting portions generates a trigger signal when triggered by the detection mark, in which the trigger signals of the respective detecting portions form the detection signal. Each of the first sub-components may be electrically connected to a controller of the electronic cigarette, respectively, for sending a trigger signal to the controller in the case of being triggered.

FIG. 9a shows a structural schematic diagram of a tobacco oil compartment loaded into an electronic cigarette according to an embodiment of the present application, and FIG. 9b shows a structural schematic diagram of a tobacco oil compartment loaded into an electronic cigarette according to another embodiment of the present application. The tobacco oil compartment of FIG. 9a is a grapefruit ice tobacco oil compartment, and the tobacco oil compartment of FIG. 9b is a spearmint tobacco oil compartment. As shown in FIGS. 9a and 9b, a detecting unit is provided on a main body portion 1 of the electronic cigarette, and the detecting unit includes a first contact sensor 11, a second contact sensor 12, and a third contact sensor 13, respectively, from the left to the right. As shown in FIG. 9a, the grapefruit ice tobacco oil compartment is provided a first bump 21 an ad second bump 22 that correspond to the first contact sensor 11 and the second contact sensor 12, so that the three contact sensors generate a detection signal of “110”. As shown in FIG. 9b, the spearmint tobacco oil compartment is provided with a first bump 21 and a third bump 23 that correspond to the first contact sensor 11 and the third contact sensor 13, so that the detection signal generated by the three contact sensors is “101”. In this embodiment, by means of different combinations of mechanical detection markings, different trigger signals are generated for the triggering of the detecting portions, thereby enabling the electronic cigarette to clearly and accurately identify the type of the tobacco oil compartment. In this embodiment, the nicotine quantity of the tobacco oil of various types of tobacco oil compartments is stored in a memory of the electronic cigarette, so that when the electronic cigarette recognizes the type of the tobacco oil compartment, the information about the nicotine quantity of the tobacco oil of the corresponding type of the tobacco oil compartment in the memory can be called up.
Step S300: according to the smoking time, the nicotine quantity of the tobacco oil, and the output power, the nicotine intake is calculated.

In one embodiment of the present application, the nicotine intake is calculated using a fitting function with the smoking time, the nicotine quantity of the tobacco oil, and the output power as variables. The fitting function is:

$$C = k * T * P * N ;$$

C is the nicotine intake in mg. k is the fitting coefficient. T is the smoking time in s. P is the output power in W, and N is the nicotine quantity of the tobacco oil in mg/ml. Specifically, according to the control variable method, the nicotine intake at different times was obtained by conducting experiments using a plurality of different output powers, and different tobacco oil compartment types. The results of these trials are then linearly fitted to obtain the fitting function described above.

Specifically, the method of the above test for the detection of nicotine quantity is as follows: the smoke generated from the electronic cigarette is collected by a Cambridge filter in series with the impinging bottle equipped with the extraction solution. After the smoking is finished, the Cambridge filter is placed in a wide-mouth bottle with a lid, and the extraction solution in the impinging bottle is added. The extraction is performed by ultrasonic extraction at room temperature for 20 min after being sealed, and then it is allowed to stand until room temperature, then filtered, and the samples are sampled and analyzed by GC-FID, thus obtaining the corresponding nicotine intake of the electronic cigarette.
Step S400: an alert message is outputted according to the nicotine intake.

In one embodiment of the present application, the step S400 further includes the following steps.

A ratio of the nicotine intake to a maximum nicotine intake is calculated, in which the maximum nicotine intake is a maximum value of the user's nicotine intake within a preset time, and the ratio is outputted.

In this embodiment, the electronic cigarette may preset the maximum nicotine intake and calculate the ratio between the calculated nicotine intake and the maximum nicotine intake, thereby alerting the user's current smoking progress and avoiding excessive nicotine intake. Specifically, the electronic cigarette may output an alert with the ratio by a display light, a display screen, a speaker, and other components.

Further, the electronic cigarette includes a plurality of display lights, and the step of outputting the ratio value further includes the following steps.

A display light ratio of one display light to all the number of display lights is calculated.

A maximum positive integer of the ratio divided by the display light ratio is determined.

A number of display lights are displayed, in which the number is the maximum positive integer.

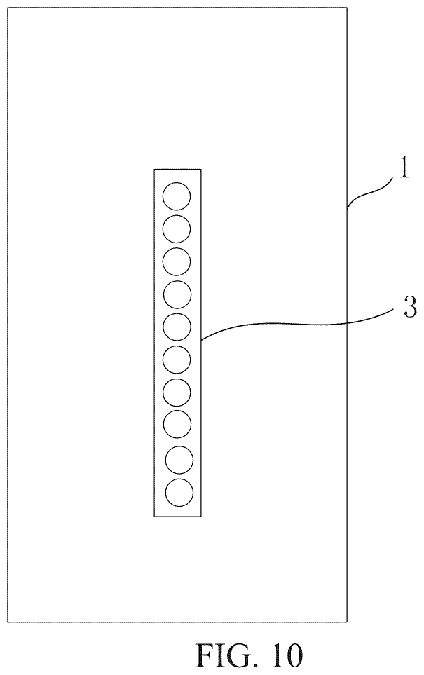

For Example, as shown in FIG. 10, the casing of the main body portion 1 of the electronic cigarette is provided with ten display lights, and the ten display lights are arranged in sequential order along a height direction of the electronic cigarette. It can be calculated that a display light ratio of one display light to all the number of display lights is 1/10 (i.e., 10%). If the ratio of the nicotine intake to the maximum nicotine intake is 33%, in this case, the ratio reaches three times the ratio of the display lights (i.e., the maximum positive integer of the ratio divided by the display light ratio is three), and thus three display lights carry out the display. It is worth noting that when the value of the maximum positive integer is greater than the value of all the numbers of the display lights, all the numbers of the display lights are displayed. Specifically, the display may be lit, blinking or changing color, etc. By adopting the manner of this embodiment, the user's current smoking progress can be visualized to avoid overdosing of nicotine. Moreover, the manner of adopting the display light is simple in structure and the display effect is intuitive.

In one embodiment of the present application, the nicotine intake alert method of the present application further includes the following steps.

A vibration prompt message and/or an acoustic alert message is outputted when the nicotine intake reaches the maximum nicotine intake.

Specifically, the electronic cigarette may be provided with a vibration motor and/or a loudspeaker. When the nicotine intake reaches the maximum nicotine intake, the controller sends a control signal so as to control the vibration motor to vibrate and/or the loudspeaker to sound an alert to remind the user to stop smoking the electronic cigarette. By adopting the technical solution of this embodiment, a tactile alert can be performed by the vibration motor and an acoustic alert can be performed by the loudspeaker, so as to allow the user to intuitively sense the nicotine intake from both tactile and auditory perception dimensions, and to avoid overdose of nicotine intake.

In the nicotine intake alert method provided in the present application, the smoking time of the user is obtained during a preset time interval, and the nicotine quantity of the tobacco oil in the tobacco oil compartment and the output power of the electronic cigarette are obtained. The nicotine intake can be calculated according to the obtained smoking time, the nicotine quantity of the tobacco oil, and the output power, so that the alert message can be output according to the nicotine intake. Accordingly, the real-time nicotine intake can be accurately calculated by combining the smoking time, the nicotine quantity of the tobacco oil, and the output power during the process of smoking the electronic cigarette, and the corresponding alert message is outputted, thereby intuitively alerting the user of the nicotine intake, avoiding the user from smoking an excessive amount of nicotine, and providing the user with a better smoking experience.

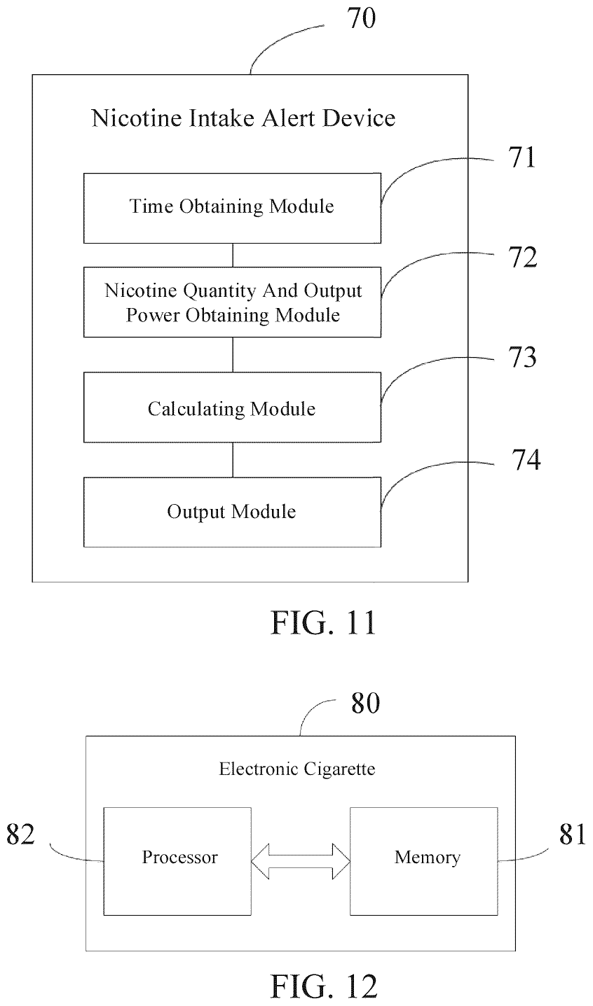

FIG. 11 shows a structural schematic diagram of a nicotine intake alert device according to an embodiment of the present application. As shown in FIG. 11, the present application provides a nicotine intake alert device 70, applied to an electronic cigarette, including:
a time obtaining module 71 configured to obtain a smoking time of a user during a preset time interval;
a nicotine quantity and output power obtaining module 72 configured to obtain a nicotine quantity of a tobacco oil in a tobacco oil compartment and an output power of the electronic cigarette;
a calculating module 73 configured to calculate a nicotine intake according to the smoking time, the nicotine quantity of the tobacco oil, and the output power; and
an output module 74 configured to output an alert message according to the nicotine intake.

In one embodiment of the present application, the smoking time is a duration from when the user triggers smoking start to when the user triggers smoking stop; or, the smoking time is a duration from when an airflow sensor of the electronic cigarette begins detecting smoke airflow to when the smoke airflow is no longer detected.

In one embodiment of the present application, the nicotine quantity and output power obtaining module 72 is further configured to receive a detection signal sent by a detecting unit of the electronic cigarette when the tobacco oil compartment is loaded with the electronic cigarette; and to determine the nicotine quantity of the tobacco oil in the tobacco oil compartment according to the detection signal.

In one embodiment of the present application, the detecting unit comprises a plurality of detecting portions, each detecting portion being configured to generate a trigger signal according to a mechanical detecting marking of the tobacco oil compartment. Accordingly, the tobacco oil nicotine quantity and output power obtaining module 72 is further configured to a trigger signal sent by each detecting portion, and to generate the detection signal according to the trigger signals of the plurality of detecting portions.

In one embodiment of the present application, the calculating module 73 is further configured to calculate the nicotine intake using a fitting function with the smoking time, the nicotine quantity of the cigarette oil, and the output power as variables, and the fitting function is:

$$C = k * T * P * N ;$$

C is the nicotine intake in mg. k is a fitting coefficient. T is the smoking time in s. P is the output power in W, and N is the nicotine quantity of the tobacco oil in mg/ml.

In one embodiment of the present application, the output module 74 is further configured to calculate a ratio of the nicotine intake to the maximum nicotine intake and output the ratio. The maximum nicotine intake is the maximum value of the user's nicotine intake in the preset time.

In one embodiment of the present application, the electronic cigarette includes a plurality of display lights, and the output module is further configured to calculate a display light ratio of one display light to all the number of display lights; determine a maximum positive integer of the ratio divided by the display light ratio; and display a number of display lights, where the number is the maximum positive integer.

In one embodiment of the present application, the electronic cigarette includes a plurality of display lights, and the output module is further configured to output a vibration alert message and/or an acoustic alert message if the nicotine intake reaches the maximum nicotine intake.

It should be noted herein that the above-described nicotine intake alert device provided in the present application is able to correspondingly realize all the roles realized by the nicotine intake alert method in the above-described embodiment, and is able to achieve the same technical effect, and the same portions of this embodiment that are the same as those of the method embodiment and the beneficial effect will not be specifically elaborated herein.

FIG. 12 is a structural schematic diagram of an electronic cigarette provided by an embodiment of the present application. As shown in FIG. 12, the electronic cigarette 80 provided by an embodiment of the present application includes a memory 81 and a processor 82.

The memory 81 is configured to store an executable program code, and the processor 82 is configured to call the executable program code in the memory 81 to execute the above-described nicotine intake alert method.

It should be noted herein that the electronic cigarette 80 provided in the present application is capable of realizing the nicotine intake alert method of the above embodiment accordingly, and is capable of achieving the same technical effect, and the same portions of this embodiment as the method embodiment and the beneficial effect will not be specifically elaborated herein.

A person of ordinary skill in the art may understand that all or some of the steps, systems, and functional modules/units in the apparatus of the method disclosed above may be implemented as software, firmware, hardware, and suitable combinations thereof. In hardware implementations, the division between functional modules/units referred to in the above description does not necessarily correspond to a division of physical components; for example, a physical component may have multiple functions, or a function or step may be cooperatively performed by several physical components. Some or all of the physical components may be implemented as software executed by a processor, such as a central processor, a digital signal processor, or a microprocessor, or as hardware, or as integrated circuits, such as specialized integrated circuits. Such software may be distributed on a computer-readable medium, which may include a computer storage medium (or non-transitory medium) and a communication medium (or transitory medium).

As is well known to those of ordinary skill in the art, the computer storage medium includes volatile and non-volatile, removable and non-removable media implemented in any method or technique for storing information, such as computer-readable instructions, data structures, program modules, or other data. Computer storage media include, but are not limited to, RAM, ROM, EEPROM, flash memory or other memory technology, CD-ROM, Digital Versatile Disk (DVD) or other optical disk storage, magnetic cartridges, magnetic tapes, magnetic disk storage, or other magnetic storage devices, or any other media that can be used to store desired information and that can be accessed by a computer.

In addition, it is well known to those of ordinary skill in the art that communication media typically contain computer-readable instructions, data structures, program modules, or other data in a modulated data signal such as a carrier wave or other transmission mechanism, and may include any information delivery medium.

In the description of embodiments of the present application, the term “and/or” denotes only one type of association relationship describing an associated object, indicating that three types of relationships may exist, e.g., A and/or B, which may denote the following: the existence of A alone, the existence of both A and B, and the existence of B alone. In addition, the term “at least one” indicates any one of the plurality or any combination of at least two of the plurality, e.g., including at least one of A, B, and may indicate any one or more elements selected from a set including A, B, and C. Furthermore, the term “plurality” means two or more, unless otherwise precisely specified.

In the description of embodiments of the present application, the terms “first”, “second”, “third”, “fourth” and the like (if present) are used to distinguish similar objects and need not be used to describe a particular order or sequence. It should be understood that the data so used may be interchangeable, where appropriate, so that the embodiments of the present application described herein can be implemented in an order other than those illustrated or described herein. In addition, the terms “comprise” and “have”, and any variations thereof, are intended to cover non-exclusive encompassing, e.g., a process, method, system, product or apparatus including a series of steps or units need not be limited to those clearly listed, but may include other steps or units that are not clearly listed or are inherent to those processes, methods, products or apparatus.

Finally, it should be noted that the above embodiments are only used to illustrate the technical solutions of the present application, and are not intended to be a limitation thereof. Although the present application has been described in detail with reference to the foregoing embodiments, a person of ordinary skill in the art should understand that it is still possible to make modifications to the technical solutions as documented in the foregoing embodiments, or make equivalent substitutions for some or all of the technical features therein. These modifications or substitutions do not take the essence of the corresponding technical solutions out of the scope of the technical solutions of the embodiments of the present application.

What is claimed is:

1. A nicotine intake alert method, applied to an electronic cigarette, comprising:
obtaining a smoking time of a user during a preset time interval;
obtaining a nicotine quantity of a tobacco oil in a tobacco oil compartment and an output power of the electronic cigarette;
calculating a nicotine intake according to the smoking time, the nicotine quantity of the tobacco oil, and the output power; and
outputting an alert message according to the nicotine intake.

2. The nicotine intake alert method of claim 1, wherein the smoking time is a duration from when the user triggers smoking start to when the user triggers smoking stop; or, the smoking time is a duration from when an airflow sensor of the electronic cigarette begins detecting smoke airflow to when the smoke airflow is no longer detected.

3. The nicotine intake alert method of claim 1, wherein the step of obtaining the nicotine quantity of the tobacco oil in the tobacco oil compartment and the output power of the electronic cigarette comprises:
receiving a detection signal sent by a detecting unit of the electronic cigarette when the tobacco oil compartment is loaded with the electronic cigarette;
determining the nicotine quantity of the tobacco oil in the tobacco oil compartment according to the detection signal.

4. The nicotine intake alert method of claim 3, wherein the detecting unit comprises a plurality of detecting portions, each detecting portion being configured to generate a trigger signal according to a mechanical detection marking of the tobacco oil compartment; accordingly, the step of receiving the detecting signal sent by the detecting unit of the electronic cigarette comprising:
receiving a trigger signal sent by each detecting portion, and generating the detection signal according to the trigger signals of the plurality of detecting portions.

5. The nicotine intake alert method of claim 1, wherein the step of calculating the nicotine intake according to the smoking time, the nicotine quantity of the tobacco oil, and the output power comprises:
calculating the nicotine intake using a fitting function with the smoking time, the nicotine quantity of the cigarette oil, and the output power as variables, wherein the fitting function is:
$$C = k * T * P * N ;$$
wherein C is the nicotine intake in mg; k is a fitting coefficient; T is the smoking time in s; P is the output power in W; and Nis the nicotine quantity of the tobacco oil in mg/ml.

6. The nicotine intake alert method of claim 1, wherein the step of outputting alert information according to the nicotine intake comprises:
calculating a ratio of the nicotine intake to a maximum nicotine intake; wherein the maximum nicotine intake is a maximum value of the nicotine intake within a preset time; and
outputting the ratio.

7. The nicotine intake alert method of claim 6, wherein the electronic cigarette comprises a plurality of display lights, and the step of outputting the ratio comprises:
calculating a display light ratio of one display light to all the number of the display lights;
determining a maximum positive integer of the ratio divided by the display light ratio; and
displaying a number of display lights, wherein the number is the maximum positive integer.

8. The nicotine intake alert method of claim 6, further comprising:
outputting at least one of a vibration alert message and an acoustic alert message when the nicotine intake reaches the maximum nicotine intake.

9. An electronic cigarette, comprising a memory and a processor;
wherein the memory is configured to store an executable program code; and
the processor is configured to call the executable program code in the memory to perform a nicotine intake alert method comprising:
obtaining a smoking time of a user during a preset time interval;
obtaining a nicotine quantity of a tobacco oil in a tobacco oil compartment and an output power of the electronic cigarette;
calculating a nicotine intake according to the smoking time, the nicotine quantity of the tobacco oil, and the output power; and
outputting an alert message according to the nicotine intake.

10. An electronic cigarette, comprising: a casing, an atomizer, a controller, a battery, and a display light;
wherein the atomizer is arranged through a top of the casing, and at least a portion of the atomizer is arranged on the top of the casing; the controller and the battery are arranged in the casing, and the atomizer and the battery are electrically connected to the controller; the display light is arranged on a surface of the casing and electrically connected to the controller; and the display light is configured to display in response to a control signal from the controller.

11. The electronic cigarette of claim 10, further comprising a timing device, which is arranged in the casing and electrically connected to the controller.

12. The electronic cigarette of claim 10, wherein the display light is a strip light, and a length direction of the strip light is parallel or perpendicular to a height direction of the casing.

13. The electronic cigarette of claim 10, wherein the display light is a strip light, the strip light encircling to form a circular shape.

14. The electronic cigarette of claim 10, wherein the number of the display lights is three, and the three display lights are sequentially arranged along a height direction of the casing.

15. The electronic cigarette of claim 10, further comprising a vibration motor, which is arranged within the casing and electrically connected to the controller.

16. The electronic cigarette of claim 10, further comprising a loudspeaker, which is arranged within the casing and electrically connected to the controller.

17. The electronic cigarette of claim 10, further comprising a button, which is provided on the casing and electrically connected to the controller.

18. The electronic cigarette of claim 17, wherein the button is a touchable button.

19. The electronic cigarette of claim 10, wherein a charging port is further provided at a bottom of the casing; the charging port is electrically connected to the battery and configured to charge the battery.
